(19) United States
(12) Patent Application Publication
(10) Pub. No.: US 2002/0026480 A1
(43) Pub. Date: Feb. 28, 2002

(54) E-mail system

(76) Inventor: Takanori Terada, Kawasaki (JP)

Correspondence Address: STAAS & HALSEY, Suite 500, 700 Eleventh Street, N.W., Washington, DC, 20001, US

(21) Appl. No.: 09/764,308

(22) Filed: Jan. 19, 2001

(30) Foreign Application Priority Data
Aug. 25, 2000 (JP) 2000-256173

(51) Int. Cl. G09G 5/00; G06F 15/16

(52) U.S. Cl. 709/206; 709/204; 345/751

(57) ABSTRACT

An E-mail device has a first detection module of detecting that a plurality of multicast target mail destination addresses exist in a hysteresis, and a generating module of executing a process of generating a group formed of the plurality of mail destination addresses, corresponding to the detection. A user is thereby made to recognize an existence of a function of registering the group of the plurality of mail destination addresses, thus guiding the user to positive utilization thereof.

### BACKGROUND OF THE INVENTION

The present invention relates generally to an E-mail system, and more particularly to a method capable of easily registering a group of mail destination addresses and an E-mail device adopting this method.

Over the recent years, E-mail services have been spreading most widely among applications and services in the communication networks. The E-mail may be defined as a technology of delivering and receiving mail data (including character data, voice data and image data) between E-mail terminal devices connected to the communication networks, i.e., between the data terminals such as computer terminals such as personal computers (PCs) and workstations (WSs).

In the E-mail system for exchanging the mail data by way of E-mails, the delivery of the E-mail from a certain E-mail terminal device to other E-mail terminal device involves specifying a mail address (which might hereinafter be simply referred to as an address) allocated to the E-mail terminal device as a destination and forwarding the mail data to the communication network.

An E-mail server (E-mail post) connected to the communication network sorts out the E-mails into predetermined mailboxes on the basis of the mail addresses (mail destination addresses). The E-mail terminal device as a receiver takes the E-mail addressed to this terminal device itself out of the mailbox, and thus receives the mail data.

This type of E-mail system incorporates additional functions such as replying, transferring, storing and further multicasting in addition to the basic functions of creating, delivering and receiving the mail. This multicasting function may be defined as a service for specifying a plurality of destinations (mail destination addresses), naming a certain group, and multicasting the same mail data to all of the plurality of destinations and all the users (members) belonging to the above group at one time.

According to the conventional E-mail system, the user is required to specify all the mail addresses when multicasting the same E-mail to the plurality of destinations at one time.

For attaining this, the user must manually input the plurality of mail destination addresses or pick up the plurality of mail destination addresses from an E-mail address list previously electronically registered in the E-mail terminal device, i.e., from a mail address book, and input these addresses.

Every address input operation is, however, laborious to the user and inefficient. Such being the case, there exists a group registration management method of creating groups each consisting the plurality of mail destination addresses, then registering these mail destination address groups in accordance with a predetermined rule, and thus managing the groups. According to this group registration management method, it is feasible to quickly specify the plurality of mail addresses belonging to a specified group.

The mail address group registering function (grouping function) described above is provided as one function mainly of an E-mail program incorporated into the E-mail terminal device. With multi-modules of the E-mail program, the users tend to occasionally miss an existence of this group registering function, and it eventually becomes chronic for the user not to use this function. Further, the operations themselves such as registering, referring to the group and so on are complicated, and hence the users might not be positive to use.

### SUMMARY OF THE INVENTION

Accordingly, it is a primary object of the present invention to provide a technology capable of enabling the user to recognize an existence of a function of registering groups each consisting of a plurality of mail destination addresses, and guiding the user to positive utilization thereof.

It is another object of the present invention to provide a technology capable of educing an operational load upon the user and enhancing an efficiency for utilizing an E-mail system.

To accomplish the above objects, according to a first aspect of the present invention, it is detected that a plurality of multicast target mail destination addresses exist in a hysteresis, and there is executed a process of generating a group formed of the plurality of mail destination addresses, corresponding to the detection.

According to a second aspect of the present invention, a group name corresponding to the mail destination address is added to group management information.

According to a third aspect of the present invention, there is provided an occasion of registering the group name corresponding to the mail destination address.

According to a fourth aspect of the present invention, the group name inputted by a user is registered in the group management information on the occasion of registering the group name.

According to a fifth aspect of the present invention, the group name is generated by a predetermined algorithm and added to the group management information.

According to the present invention, it is possible to make the user recognize the existence of the function of registering the group formed of the plurality of mail destination addresses, and to guide the user to positive utilization thereof.

Further, according to the present invention, it is feasible to enhance the efficiency for utilizing the E-mail system by reducing the operational load upon the user. Namely, the user is able to register the address group simply by answering a question of whether a group candidate displayed is to be registered as a formal group without performing complicated steps.

As a result, even beginners and users of this sort, who tend not to read the operation manual and continue to use the system in an as-unrecognized state with respect to an existence of the mail address group registering function in spite of its being incorporated therein, are easy to recognize the mail address group registering function and input the plurality of multicast target mail addresses.

### BRIEF DESCRIPTION OF THE DRAWINGS

These objects and advantages of the present invention will become more apparent and more readily appreciated from the following detailed description of the presently preferred exemplary embodiments, taken in conjunction with the accompanying drawings of which:

FIG. 1 is a block diagram showing an architecture of an E-mail system in one embodiment of the present invention;

FIG. 2 is a block diagram showing a detailed architecture of an E-mail terminal device in FIG. 1;

FIG. 3 is a diagram showing an example of a detailed structure of a hysteresis table;

FIG. 4 is a flowchart showing steps of a group registering process;

FIG. 5 is a diagram explaining a trigger for executing a group registering process;

FIG. 6 is a diagram showing a dialog screen for creating a mail;

FIG. 7 is a diagram showing a dialog screen for setting an input count;

FIG. 8 is a diagram showing a group name auto registration setting dialog screen;

FIG. 9 is a diagram showing a dialog screen for registering a mail address group name; and

FIG. 10 is a diagram showing a mail address group edit dialog screen.

### DETAILED DESCRIPTION OF THE PREFERRED EMBODIMENTS

Embodiments of the present invention will hereinafter be described with reference to the accompanying drawings.

[Architecture of E-mail System]

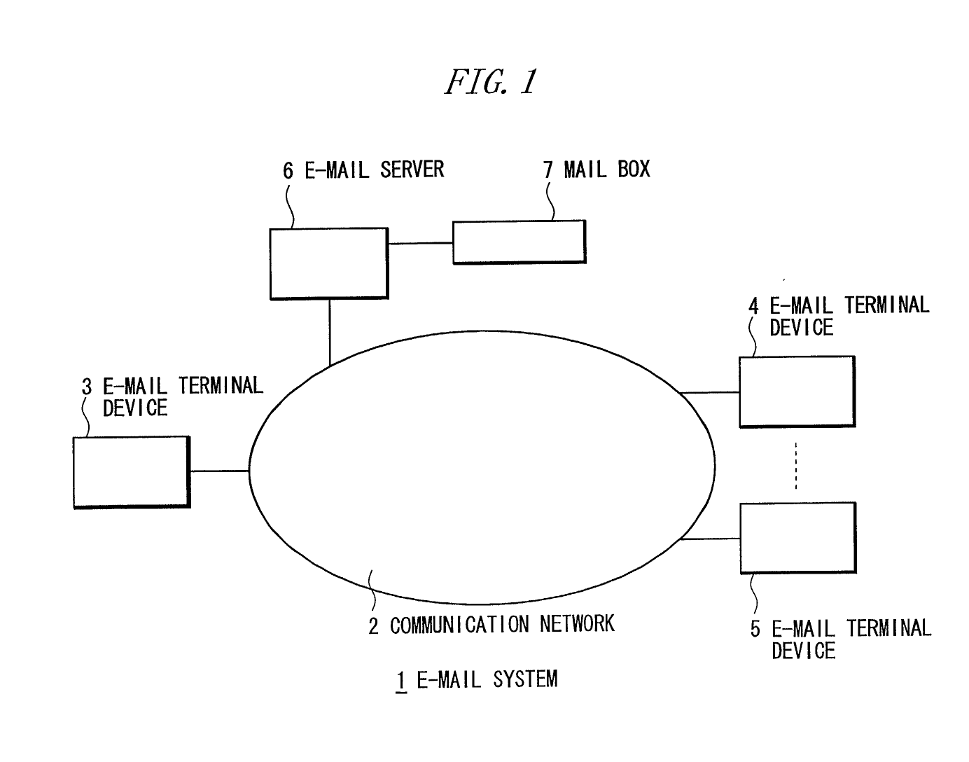

FIG. 1 shows an architecture of an E-mail system in one embodiment of the present invention. Referring to FIG. 1, an E-mail system 1 includes a plurality of E-mail terminal devices 3, 4, 5 each accommodated in a communication network 2, and an E-mail server (E-mail post) 6. The communication network 2 is configured by the Internet or Intranet.

Each of the E-mail terminal device 3, 4, 5 is constructed of a computer terminal such as a personal computer (PC) and a data terminal such as a workstation (WS). Mail addresses unique to each other are allocated to the respective E-mail terminal devices.

Further, each E-mail terminal device has a mail address book. The E-mail terminal device has E-mail software (program and data), and sends and receives an E-mail via the communication network 2 and the E-mail server 6 by booting the E-mail software. Users can be thereby provided with E-mail services.

The E-mail server 6 has a mailbox 7 and an unillustrated mailing list. The mailbox 7 has storage areas allocated for storing mail data for every address of an E-mail receiver (destination). An E-mail addressed and sent to a certain E-mail terminal device from one other E-mail terminal device is stored in a corresponding storage area in this mailbox 7, and the E-mail terminal device as the destination reads the mail data from the storage area thereof, thus completing the delivery and receipt of the E-mail.

[Architecture of E-mail Terminal Device]

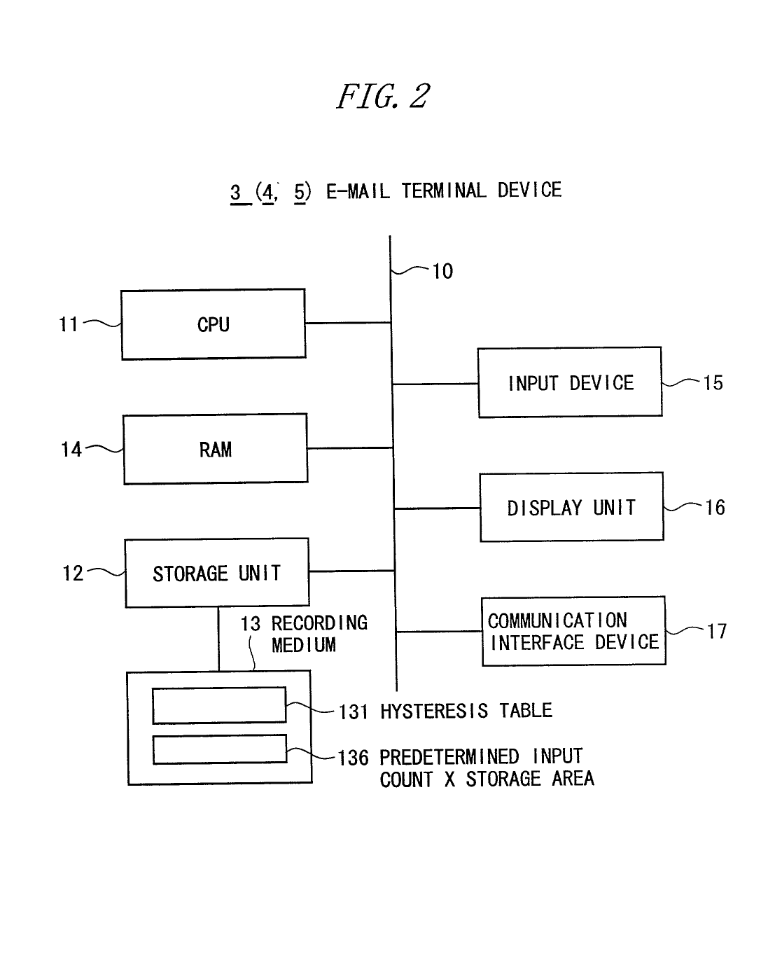

FIG. 2 illustrates an architecture of the E-mail terminal device 3 (4, 5) in the E-mail system 1 described above. Referring to FIG. 2, the E-mail terminal device includes, as in the case of a typical PC, a control unit (CPU) 11, a storage unit 12, a recording medium 13, a main storage unit (RAM) 14, an input device 15, a display unit 16 and a communication interface device 17, which are connected to each other via an internal bus 10.

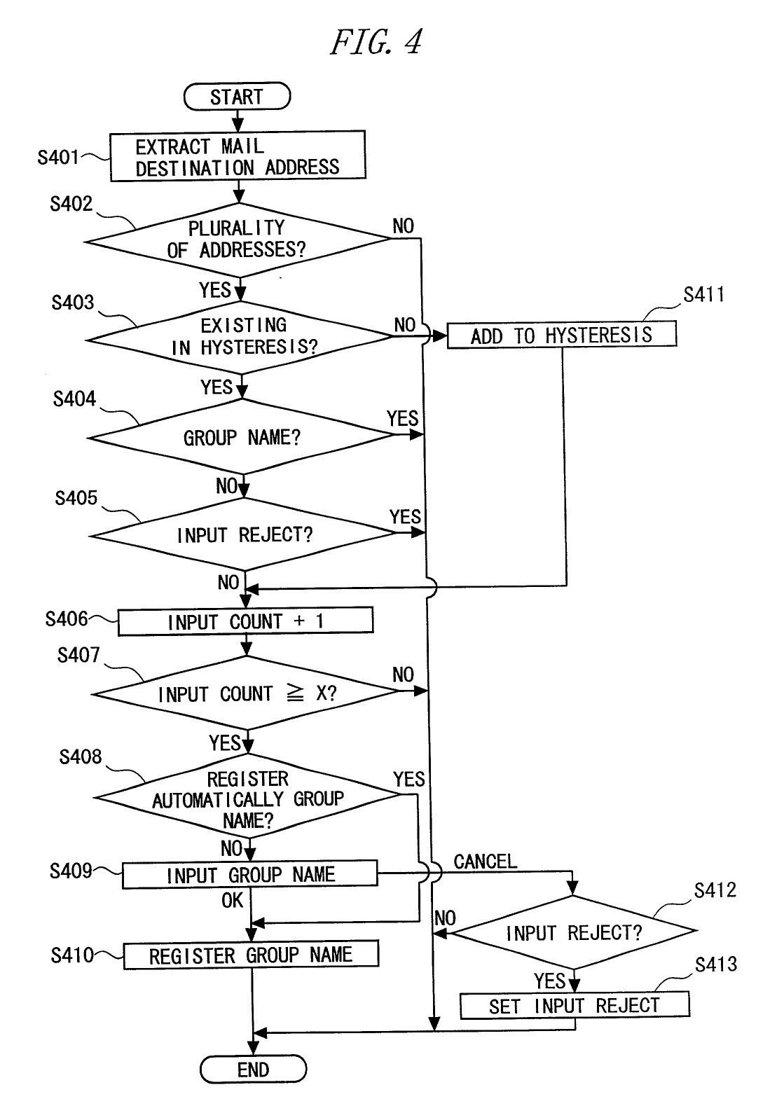

The CPU 11 reads an existing E-mail program containing a group registration program (see FIG. 4) that will hereinafter be explained in depth from the storage unit 12, and executes these programs. The RAM 14 is used as a main storage area for the CPU 11.

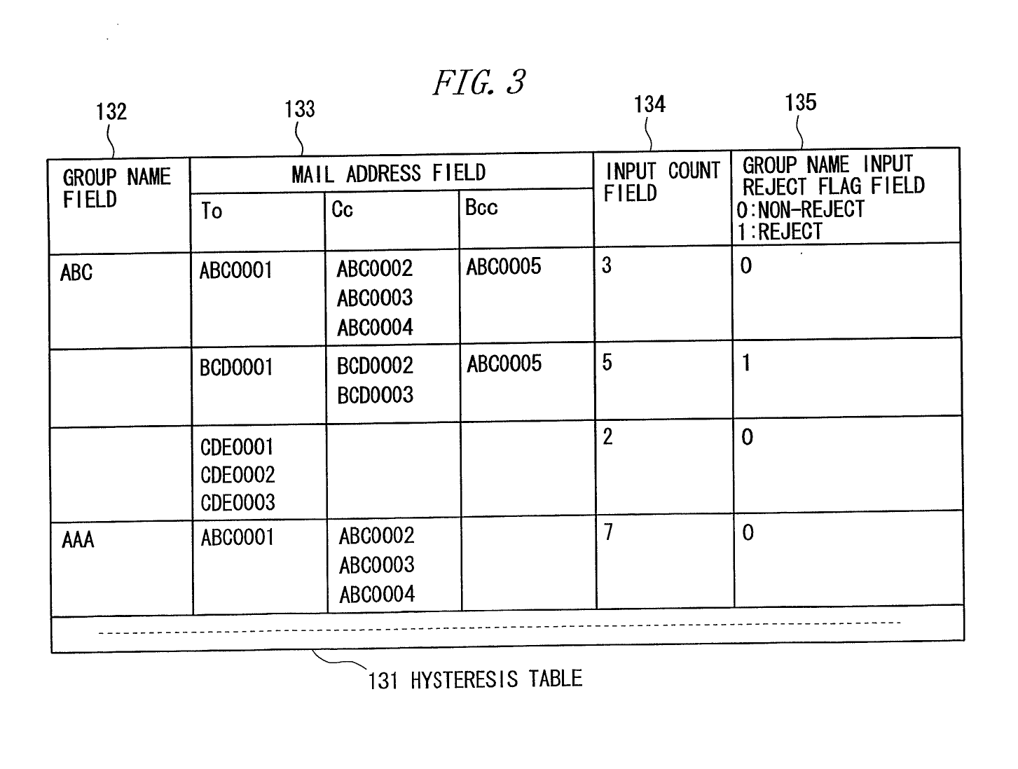

The storage unit 12 such as a hard disk device has the recording medium 13 stored previously with the programs executed by the CPU 11 and with data. The mail address book described above and a hysteresis table 131 (see FIG. 3) that will be explained in details later on, are stored on the recording medium 13. This recording medium 13 may take a form of being fixedly provided in or detachably attached to the storage unit 12.

The input device 15 is constructed of a keyboard and a mouse. The input device 15 is used for creating the E-mail and inputting commands in order for the COU 11 to execute a specified program. The display unit 16 is a display for visually displaying a processing result by the CPU 11 to the user. The communication interface device 17 serves to connect the E-mail terminal device to the communication network 2, and to send and receive the E-mail to and from the E-mail server 6 on the basis of an indication given from the CPU 11.

FIG. 3 shows an example of structure of the hysteresis table 131 stored on he recording medium 13. This hysteresis table 131 consists of fields such as a group name field 132, a mail address field 133, an input count field 134 and a group name input reject flag filed 135.

Group names given to a plurality of mail destination addresses are registered in the group name field 132. If the group name field 132 is blank, this implies that a group name is not yet registered. A plurality of mail addresses to which the mail is multicast are registered per group in the mail address field 133.

The number of inputs (count value) with a combination of the same mail addresses for the purpose of delivering the E-mail, is registered in the input count field 134. Further, binary data (0: non-reject, 1: reject) indicating whether or not the group name is registered in the hysteresis table 131, are registered in the group name input reject flag field 135.

To describe it in greater details, each of the E-mail terminal devices 3, 4, 5 incorporates the following functions for a group registering (group generating) process of the plurality of mail destination addresses. Namely, each E-mail terminal device has a first detection function of detecting that a plurality of multicast target mail destination addresses exist in the hysteresis, and a generating function of executing the process of generating the group consisting of the plurality of mail destination addresses.

Further, each the E-mail terminal device further has a second detection function of detecting that there does not exist the group corresponding to the mail destination addresses existing in the hysteresis, and the generating function implements the process of generating the group if there exists no group corresponding to the mail destination address.

Moreover, the generating function of each E-mail terminal device includes an adding function of adding a group name corresponding to the mail destination address to group management information. The adding function includes a providing function of providing an occasion of registering the group name corresponding to the mail destination address. The adding function further includes a first registering function of registering he group name inputted by the user in the group management information described above.

The adding function further includes a second registering function of registering registration rejected state information in the group management information when a registration of the group name is rejected by the user. The adding function generates the group name on the basis of a predetermined algorithm, and adds the thus generated group name to the group management information.

Further, each E-mail terminal device further includes a setting function of setting a mail destination address input count in the hysteresis in order to provide the occasion of registering the group name, and a selecting function by which the user selects whether the group generating process is to be executed or not.

[Group Registering Process for Mail Addresses]

Next, referring to FIGS. 1, 2 and related drawings in combination, a group registering process for the mail addresses in the E-mail terminal devices 3, 4, 5 in the E-mail system 1, will be explained.

In each of the E-mail terminal devices, the CPU 11 reads the E-mail program containing the mail address group registration program, of which processing steps are shown in FIG. 4, from the recording medium 13 of the storage unit 12 onto the RAM 14 and executes this program. In the execution of this processing, the RAM 14 is used as the main storage area for the CPU 11.

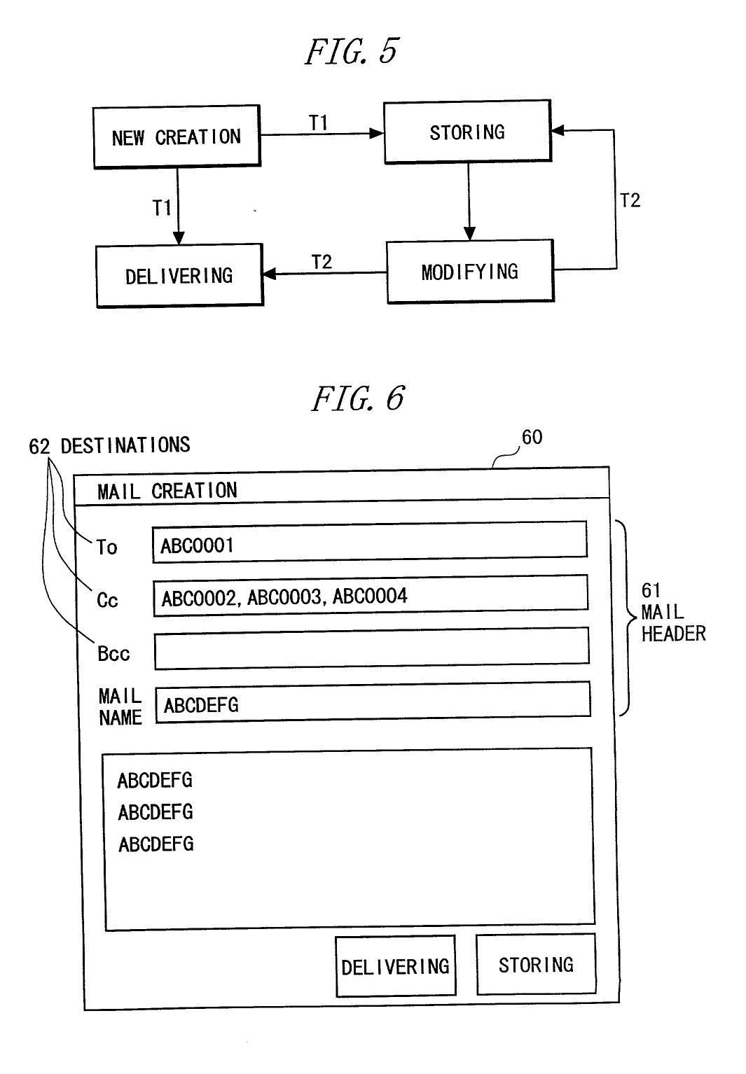

In each E-mail terminal device, the execution of the group registering process is triggered by delivering or storing (Ti) an E-mail created fresh, and by delivering or storing (T2) the already-stored E-mail of which the destination address has been modified, shown in FIG. 5.

For example, in the E-mail terminal device 3, when the user newly creates and delivers an E-mail having a content displayed on a mail creation dialog screen 60 shown in FIG. 6 (which corresponds to the trigger T1 in FIG. 5), the CPU 11 extracts mail addresses [To:ABC0001, Cc:ABC0002, ABC0003, ABC0004] out of mail headers 61 of delivery target E-mails, sorts out the addresses according to destinations 62 (To, Cc, Bcc), and stores the sorted-out addresses in the RAM 14 (step S401 in FIG. 4).

The CPU 11 judges whether a single or a plurality of mail addresses are stored in the RAM 14 (S402). If the single mail address is stored, the CPU 11 proceeds to a group registration end process.

The CPU 11 reads a hysteresis from the hysteresis table 131 of the recording medium 13, and searches whether or not that combination of mail addresses exist therein (S403). If this combination of mail addresses exist, the CPU 11 stores this group in the RAM 14.

Whereas if not, the CPU 11 adds that combination of mail addresses as a new hysteresis to the hysteresis table 131, and proceeds to S406. Note that the CPU 11 may divert to S404 as a substitute option for S406. In this case, a content of the added hysteresis is that the group name is [unnamed], the input count is [0], and the group name input reject flag is [non-reject: 0]. Incidentally, the search for the combination of the mail addresses in S403 involves the use of a complete coincidence searching method, however, a partial coincidence searching method may also be used.

The CPU 11 checks whether or not the group name is set in the group searched in S403 (S404). If the group name is set, the CPU 11 proceeds to the group registration end process. Note that if the group name is registered in the hysteresis table 131, the user is able to multicast the E-mail to a plurality of mail addresses belonging to the mail address group simply by inputting a group name of this group.

Whereas if the group name is not set, the CPU 11 checks referring to the hysteresis table 131 whether or not [reject: 1] is set as the group name input reject flag in that group (S405).

If the group name input reject flag is not set as a rejection, the CPU 11 increments by 1 (+1) an input count of the group searched in S403, and registers this group in the hysteresis table 131 (S406) Note that if the group name input reject flag is set as the rejection, the CPU 11 comes to the end process.

The CPU 11 checks referring to the hysteresis table 131 whether or not the input count of the group searched in S403 is equal to or larger than a predetermined count X. As a result, if the input count is not the predetermined count X or larger, the CPU 11 comes to the end process. Further, if being the predetermined count X or larger, the CPU 11 proceed to net step S408 (S407).

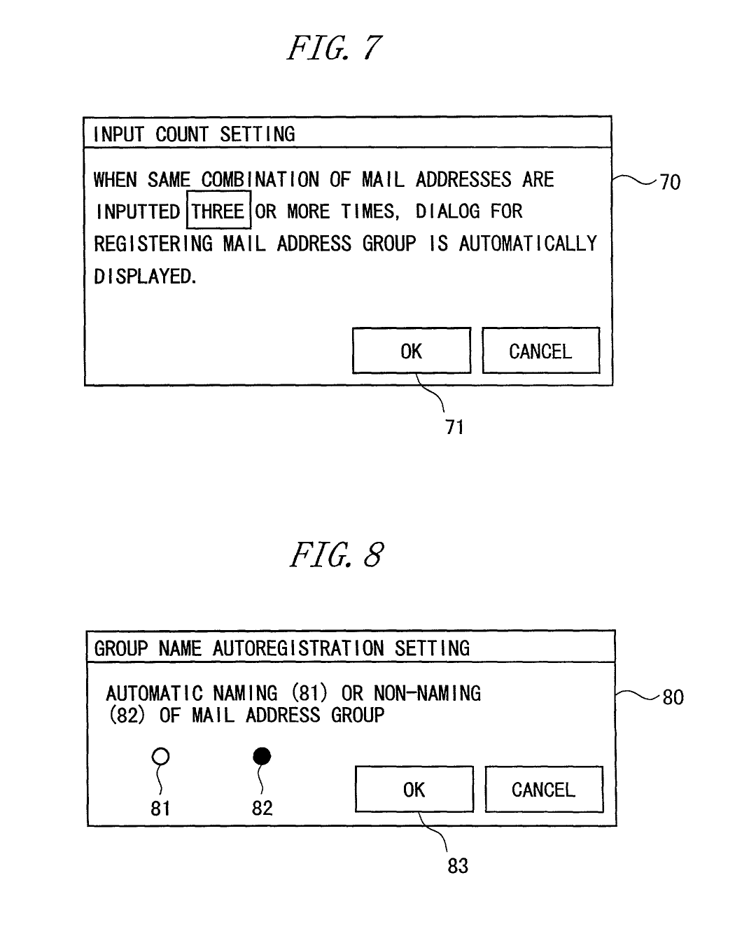

Herein, a default value of the predetermined count X is [3]. The user may change and set the predetermined count X on the dialog screen 70, displayed on the display unit 16, for setting the input count as shown in FIG. 7. On this dialog screen 70, when the user clicks (selects) an [OK] button 71 by use of the mouse as the input device 15, a set content is stored in a predetermined count storage area 136.

In this group registration process, a serial number can be automatically given and thus registered as a group name without inquiring the user about the group name (S408). Whether or not the serial number is automatically given and registered as the group name, can be set by displaying a group name auto registration setting dialog screen 80 shown in FIG. 8 on the display unit 16.

On this dialog screen 80, when the user selects a [naming] radio button 81 and then clicks an [OK] button 83, because of being the group name auto registration setting, a serial number is stored as a group name in the hysteresis table 131 in S410. While on the other hand, when the user selects an [non-naming] radio button 82 and then clicks the [OK] button 83, because of not being the group name auto registration setting, the CPU 11 proceeds to next step S409.

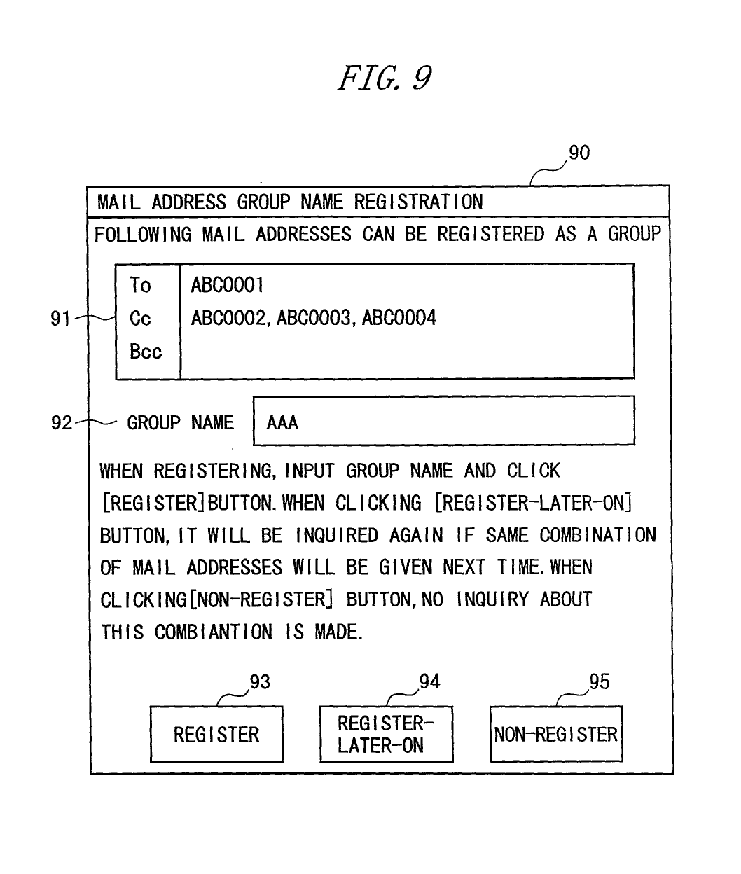

The CPU 11 displays on the display unit 16 a dialog screen 90 for registering a group name of the mail addresses shown in FIG. 9, and inquires the user about an intention of registering the group name. The user refers to mail addresses [To: ABC0001, Cc: ABC0002, ABC0003, ABC0004] displayed in a destination display box 91 on the dialog screen 90, and, if desiring for registering the group name, inputs a desire-for-registration group name [AAA] in a group name box 92 by use of a keyboard as the input device 15. Thereafter, the user selects a [register] button 93 (S409). The group name [AAA] is thereby registered in the hysteresis table 131 (S410).

Further, when the user selects a [register-later-on] button 94 on this dialog screen 90, if requested to deliver the E-mail with the same combination of mail addresses next time, the intention of registering the group name is again inquired of the user (S409, S412).

Moreover, when the user selects a [non-register] button 99 on this dialog screen 90, the intention of registering the group name is not again inquired of the user with this combination of mail addresses. When the user selects the [non-register] button 95, the CPU 11 judges in S412 that it is the group name input rejection, and sets [reject: 1] in the group name input reject flag in the hysteresis table 131 in S413 (S409, S412, S413).

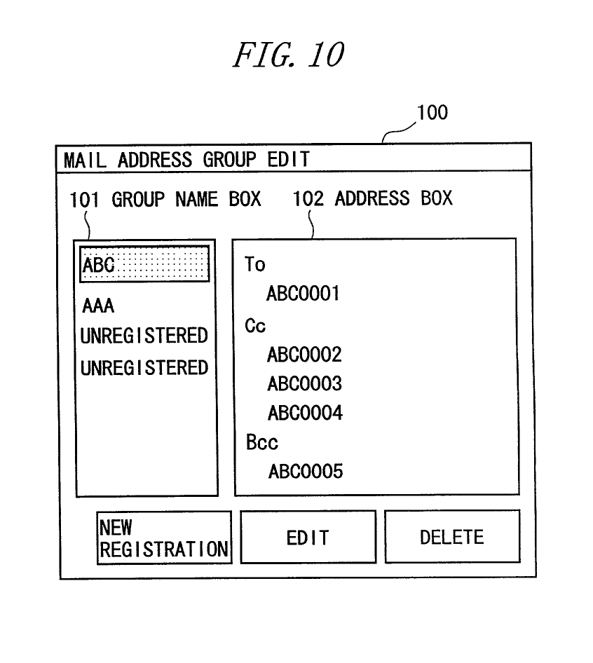

In the group registration program described above, a mail address group edit dialog screen 100 shown in FIG. 10 is displayed on the display unit 16, and the user is thereby able to newly manually create and edit or delete a mail address group.

On this dialog screen 100, the groups registered and unregistered in the hysteresis table 131 are displayed in a group name box 101. Mail addresses belonging to the groups selected in the group name box 101 are displayed in an address box 102.

The display example illustrated herein shows a state where when the user selects a group name [ABC] in the group name box 101, a plurality of mail addresses belonging to this group are displayed in the address box 102. Note that the groups in which the group name input reject flag is set and the groups of which the input count is under the predetermined count X, are also displayed as being [unregistered] , and the group registration can be thus manually conducted.

[Modified Example]

The processes in the embodiment discussed above are actualized in the form of a program executable by a computer, and this program can be recorded on a recording medium such as a CD-ROM, a floppy disk etc and may further be provided via communication lines.

The embodiment discussed above takes the mode in which the hysteresis table is created including the destination attributes such as To, Cc, Bcc, and the groups are generated based on these destination attributes. Thus, the groups are generated based on the destination attributes, thereby reducing an operational load upon the user such as specifying the destination attribute in the case of addressing the mail when delivering it. The present invention is not, however, limited to this mode. Combinations of the mail addresses simply specified as multicast destinations are retained in the hysteresis table, and the groups may be generated by use of only the combinations of mail addresses without accounting for the destination attributes.

Further, in the embodiment discussed above, the groups (group names) used for delivering the mails are registered in the hysteresis table for storing the hysteresis of the mail deliveries. The present invention is not, however, confined to this mode. In a mode where the group name corresponding to the plurality of mail addresses is registered in the mail address book or other management file, the group name of the group to be generated may be registered in the mail address book or the management file.

Further, as for the trigger for executing the group registering process, this group registering process may be booted at a predetermined time interval by use of a timer, and so on. The trigger for starting the process is not limited to those described in the embodiment discussed above.

Moreover, in accordance with the embodiment discussed above, the E-mail program contains the group registration program, however, the group registration program may also be provided as a separate program from the E-mail program.

In the embodiment discussed above, the E-mail terminal device (i.e., a client) executes the group registering process according to the present invention, however, other devices such as the E-mail server may also execute this process.

In the case where the E-mail server executes the group registering process, the plurality of multicast target mail addresses are detected from pieces of header information of the E-mails received from the E-mail terminal devices and registered in the hysteresis table, and the group registering process according to the present invention is carried out. The registration of the group name involves inquiring the E-mail terminal device as to whether the registration is necessary or unnecessary, and, if indicated to register the group name, it follows that the group name is registered in the group management information retained by the E-mail terminal device. Further, if indicated to register, there may take such a method that the E-mail server registers it as an address in a mailing list.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. An E-mail device comprising:
a first detection module of detecting that a plurality of multicast target mail destination addresses exist in a hysteresis; and
a generating module of executing a process of generating a group formed of the plurality of mail destination addresses, corresponding to the detection.

2. An E-mail device according to claim 1, further comprising a second detection module of detecting that there does not exist the group corresponding to the mail destination addresses existing in the hysteresis,
wherein said generating module executes the process of generating the group if there does not exist the group corresponding to the mail destination address.

3. An E-mail device according to claim 1, wherein said generating module includes an adding module of adding the group name corresponding to the mail destination address to group management information.

4. An E-mail device according to claim 3, wherein said adding module includes a providing module of providing an occasion of registering the group name corresponding to the mail destination address.

5. An E-mail device according to claim 4, wherein said adding module further includes a first registering module of registering the group name inputted by a user in the group management information on the occasion of registering the group name.

6. An E-mail device according to claim 5, wherein said adding module further includes a second registering module of registering a piece of registration reject state information in the group management information when the user rejects the registration of the group name on the occasion of registering the group name.

7. An E-mail device according to claim 4, further comprising a setting module of setting an input count of the mail destination address in the hysteresis in order to provide the occasion of registering the group name.

8. An E-mail device according to claim 3, wherein said adding module generates the group name by a predetermined algorithm and adds this group name to the group management information.

9. An E-mail device according to claim 1, further comprising a selecting module of enabling the user to select whether the process of generating the group is to be executed or not.

10. A method of generating a group of mail addresses, comprising:
detecting that a plurality of multicast target mail destination addresses exist in a hysteresis; and
executing a process of generating a group formed of the plurality of mail destination addresses, corresponding to the detection.

11. A method of generating a group of mail addresses according to claim 10, further comprising:
detecting that there does not exist the group corresponding to the mail destination addresses existing in the hysteresis; and
executing the process of generating the group if there does not exist the group corresponding to the mail destination address.

12. A method of generating a group of mail addresses according to claim 10, further comprising:
adding the group name corresponding to the mail destination address to group management information.

13. A method of generating a group of mail addresses according to claim 12, further comprising:
providing an occasion of registering the group name corresponding to the mail destination address.

14. A method of generating a group of mail addresses according to claim 13, further comprising:
registering the group name inputted by a user in the group management information on the occasion of registering the group name.

15. A method of generating a group of mail addresses according to claim 14, further comprising:
registering a piece of registration reject state information in the group management information when the user rejects the registration of the group name on the occasion of registering the group name.

16. A method of generating a group of mail addresses according to claim 13, further comprising:
setting an input count of the mail destination address in the hysteresis in order to provide the occasion of registering the group name.

17. A method of generating a group of mail addresses according to claim 12, further comprising:
generating the group name by a predetermined algorithm and adding this group name to the group management information.

18. A method of generating a group of mail addresses according to claim 10, further comprising:
enabling the user to select whether the process of generating the group is to be executed or not.

19. A readable-by-computer medium recorded with a program, executed by a computer, comprising:
a step of detecting that a plurality of multicast target mail destination addresses exist in a hysteresis; and
a step of executing a process of generating a group formed of the plurality of mail destination addresses, corresponding to the detection.

20. A readable-by-computer medium recorded with a program, executed by a computer according to claim 19, further comprising:
a step of detecting that there does not exist the group corresponding to the mail destination addresses existing in the hysteresis; and
a step of executing the process of generating the group if there does not exist the group corresponding to the mail destination address.

21. A readable-by-computer medium recorded with a program, executed by a computer according to claim 19, further comprising a step of adding the group name corresponding to the mail destination address to group management information.

22. A readable-by-computer medium recorded with a program, executed by a computer according to claim 21, further comprising a step of providing an occasion of registering the group name corresponding to the mail destination address.

23. A readable-by-computer medium recorded with a program, executed by a computer according to claim 22, further comprising a step of registering the group name inputted by a user in the group management information on the occasion of registering the group name.

24. A readable-by-computer medium recorded with a program, executed by a computer according to claim 23, further comprising a step of registering a piece of registration reject state information in the group management information when the user rejects the registration of the group name on the occasion of registering the group name.

25. A readable-by-computer medium recorded with a program, executed by a computer according to claim 22, further comprising a step of setting an input count of the mail destination address in the hysteresis in order to provide the occasion of registering the group name.

26. A readable-by-computer medium recorded with a program, executed by a computer according to claim 21, further comprising a step of generating the group name by a predetermined algorithm and adding this group name to the group management information.

27. A readable-by-computer medium recorded with a program, executed by a computer according to claim 19, further comprising a step of enabling the user to select whether the process of generating the group is to be executed or not.
